(19) United States
(12) Patent Application Publication
(10) Pub. No.: US 2025/0254510 A1
(43) Pub. Date: Aug. 7, 2025

(54) CONTROL OF A WIRELESS COMMUNICATION DEVICE IN A VISITED WIRELESS COMMUNICATION NETWORK

(71) Applicant: T-MOBILE INNOVATIONS LLC, Overland Park, KS (US)

(72) Inventors: Subramania Kaushik, Bellevue, WA (US); Anil Kumar Mariyani, Ashburn, VA (US); Srujana Punyapu, Seattle, WA (US)

(21) Appl. No.: 18/434,058

(22) Filed: Feb. 6, 2024

(51) Int. Cl. H04W 8/08; H04W 48/18; H04W 84/04

(52) U.S. Cl. CPC H04W 8/082; H04W 48/18; H04W 84/042

(57) ABSTRACT

A wireless device is controlled in a visited wireless network. A network database stores a prioritized network list for the visited wireless network. A network controller receives a request from the visited wireless network for the wireless device, and in response, retrieves the prioritized network list for the visited wireless network from the network database. The network controller transfers the prioritized network list to the wireless device over the visited wireless network. The network controller stores the prioritized network list for the visited wireless network in a controller memory. The network controller receives another request from the visited wireless network for the wireless device, and in response, retrieves the prioritized network list for the visited wireless network from the controller memory. The network controller transfers the prioritized network list to the wireless device over the visited wireless network. The wireless device wirelessly communicates based on the prioritized network list.

### TECHNICAL BACKGROUND

Wireless communication networks provide wireless data services to wireless communication devices like phones, computers, and other user devices. The wireless data services may include internet-access, data messaging, video conferencing, or some other data communication product. The wireless communication networks comprise wireless access nodes like Wireless Fidelity (WIFI) hotspots, Fifth Generation New Radio (5GNR) cell towers, and satellites in earth orbit. The different types of wireless access nodes represent different access technologies. The wireless communication networks further comprise network elements the process network signaling and handle user data like Access and Mobility Management Functions, User Plane Functions (UPFs), Unified Data Management (UDMs), and Application Functions (AFs). Different sets of wireless access nodes and network elements represent different Public Land Mobile Networks (PLMNs). Thus, a wireless communication network may offer several types of access technologies and several different PLMNs.

The wireless communication devices are homed to a home wireless communication network. The wireless communication devices use visited wireless communication networks when their home wireless communication network is not available. The visited wireless communication networks communicate with the home wireless communication networks to obtain authorization to serve the visiting wireless communication devices. The visited wireless communication networks also communicate with the home wireless communication networks to obtain instructions on how to serve the visiting wireless communication devices. One such piece of information comprises a network list that instructs the visiting wireless communication devices to select the highest priority access technologies and PLMNs that are available in the visited wireless communication networks. A special network element—called a Steering-of-Roaming AF—is used to serve these network lists to the wireless communication devices over other network elements.

Unfortunately, the use of the SoR AF to serve the network lists generates excessive signaling that consumes network resources. Moreover, the use of the SoR AF to serve the network lists creates delay in delivering wireless communication services in the visited wireless communication networks.

### Technical Overview

In some examples, a wireless device is controlled in a visited wireless network. A network database stores a prioritized network list for the visited wireless network. A network controller receives a request from the visited wireless network for the wireless device, and in response, retrieves the prioritized network list for the visited wireless network from the network database. The network controller transfers the prioritized network list to the wireless device over the visited wireless network. The network controller stores the prioritized network list for the visited wireless network in a controller memory. The network controller receives another request from the visited wireless network for the wireless device, and in response, retrieves the prioritized network list for the visited wireless network from the controller memory. The network controller transfers the prioritized network list to the wireless device over the visited wireless network. The wireless device wirelessly communicates based on the prioritized network list.

In some examples, roaming devices are controlled in visited wireless networks. A Steering-of-Roaming Application Function (SoR-AF) stores sets of Public Land Mobile Network Identifiers (PLMN IDs) for the visited wireless networks. A Uniform Data Management (UDM) receives roaming requests from the visited wireless networks for the roaming devices, and in response, retrieves the sets of the PLMN IDs for the visited wireless networks from the SoR-AF. The UDM transfers the sets of the PLMN IDs to the roaming devices over the visited wireless networks. The UDM stores the sets of the PLMN IDs for the visited wireless networks in a UDM memory. The UDM receives other additional roaming requests from the visited wireless networks for the roaming devices, and in response, retrieves the sets of the PLMN IDs for the visited wireless networks from the UDM memory. The UDM transfers the sets of the PLMN IDs to the roaming devices over the visited wireless networks. The roaming devices wirelessly communicate based on the sets of the PLMN IDs.

### DESCRIPTION OF THE DRAWINGS

FIG. 1 illustrates an exemplary data communication system to control a roaming wireless device in a visited wireless network.

FIG. 2 illustrates an exemplary operation of the data communication system to control the roaming wireless device in the visited wireless network.

FIG. 3 illustrates an exemplary operation of the data communication system to control the roaming wireless device in the visited wireless network.

FIG. 4 illustrates exemplary processing circuitry to control roaming wireless devices visited wireless networks.

FIG. 5 illustrates an exemplary wireless communication system to control roaming wireless User Equipment (UEs) in visited wireless communication networks.

FIG. 6 illustrates an exemplary UE in the wireless communication system to control the roaming wireless UEs in the visited wireless communication networks.

FIG. 7 illustrates an exemplary Fifth Generation New Radio (5GNR) access node in the wireless communication system to control the roaming wireless UEs in the visited wireless communication networks.

FIG. 8 illustrates an exemplary Wireless Fidelity (WIFI) access node in the wireless communication system to control the roaming wireless UEs in the visited wireless communication networks.

FIG. 9 illustrates an exemplary satellite access node and ground station in the wireless communication system to control the roaming wireless UEs in the visited wireless communication networks.

FIG. 10 illustrates an exemplary visited wireless communication network in the wireless communication system to control the roaming wireless UEs in the visited wireless communication networks.

FIG. 11 illustrates an exemplary home wireless communication network in the wireless communication system to control the roaming wireless UEs in the visited wireless communication networks.

FIG. 12 illustrates an exemplary operation of the wireless communication system to control the roaming wireless UEs in the visited wireless communication networks.

FIG. 13 illustrates an exemplary operation of the wireless communication system to control the roaming wireless UEs in the visited wireless communication networks.

### DETAILED DESCRIPTION

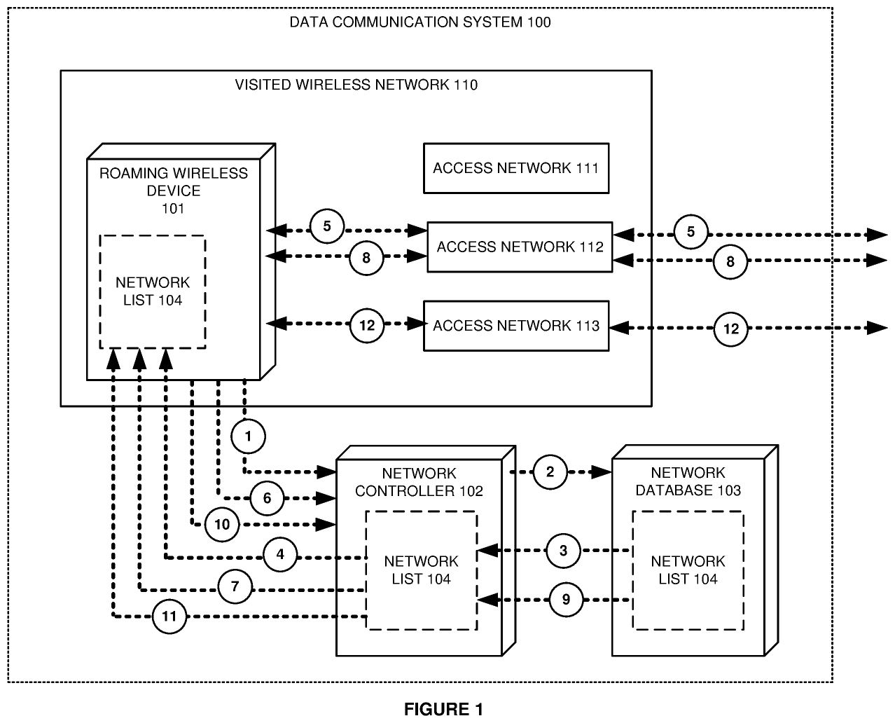

FIG. 1 illustrates exemplary data communication system 100 to control roaming wireless device 101 in visited wireless network 110. Data communication system 100 comprises network controller 102, network database 103, and visited wireless network 110. Visited wireless network 110 comprises roaming wireless device 101 and access networks 111-113. Roaming wireless device 101 comprises a phone, computer, vehicle, sensor, or some other data communication apparatus. Network controller 102 comprises one or more network elements that control the delivery of wireless communication services to user devices like roaming wireless device 101. Network database 103 comprises one or more network elements that store data like network list 104 to support network controller 102. Access networks 111-113 comprise one or more network elements that exchange user data between roaming wireless device 101 and other data systems (not shown). The amount of wireless devices, wireless networks, and access networks that are shown on FIG. 1 has been restricted for clarity.

Network database 103 initially stores prioritized network list 104 for visited wireless network 110. Prioritized network list 104 is subsequently propagated to network controller 102 and then to roaming wireless device 101. Roaming wireless device 101 selects access networks 111-113 based on prioritized network list 104. Thus, prioritized network list 104 indicates individual ones of access networks 111-113 that roaming wireless device 101 should use when in visiting wireless network 110.

In some examples, a network controller 102 receives a request from visited wireless network 101 for roaming wireless device 101 (arrow #1). The request is for authorization to serve roaming wireless device 101. In response to the request, network controller 102 authorizes roaming wireless device 101 to use visited wireless network 110. In response to the authorization, network controller 102 retrieves prioritized network list 104 for visited wireless network 110 from network database 103 (arrows #2-3). Network controller 102 transfers prioritized network list 104 to roaming wireless device 101 over visited wireless network 110 (arrow #4). Network controller 102 stores prioritized network list 104 for visited wireless network 110 in a controller memory that typically resides in network controller 102. Roaming wireless device 101 selects access network 112 based on prioritized network list 104. Roaming wireless device 101 exchanges user data with the other data systems over access network 112 (arrows #5)

Subsequently, network controller 102 receives another request from visited wireless network 110 for roaming wireless device 101 (arrow #6). The other request is for authorization to serve roaming wireless device 101. In response to the other request, network controller 102 authorizes roaming wireless device 101 to use visited wireless network 110. In response to the authorization, network controller 102 retrieves prioritized network list 104 for visited wireless network 110 from the controller memory. Note that network controller 102 does not need to retrieve prioritized network list 104 from network database 103. Network controller 102 transfers prioritized network list 104 to roaming wireless device 101 over visited wireless network 110 (arrow #7). Roaming wireless device 101 selects access network 112 based on prioritized network list 104. Roaming wireless device 101 exchanges user data with the other data systems over access network 112 (arrows #8).

Network list 104 is then modified in network database 103. For example, the priorities of access networks 112-113 may change, so access network 113 now has a higher priority than access network 112. In response to the prior use of prioritized network list 104 or a subscription to list modifications by network controller 102, network database 103 automatically pushes modified and prioritized network list 104 to network controller 102 (arrow #9). Network controller 102 stores modified and prioritized network list 104 for visited wireless network 110 in the controller memory. Network controller 102 then receives another request from visited wireless network 110 for roaming wireless device 101 (arrow #10). In response to this other request, network controller 102 authorizes roaming wireless device 101 to use visited wireless network 110. In response to the authorization, network controller 102 retrieves modified and prioritized network list 104 for visited wireless network 110 from the controller memory. Note that network controller 102 does not need to retrieve modified and prioritized network list 104 from network database 103. Network controller 102 transfers modified and prioritized network list 104 to wireless device 101 over visited wireless network 110 (arrow #11). Roaming wireless device 101 selects access network 113 based on modified and prioritized network list 104. Roaming wireless device 101 exchanges user data with the other data systems over access network 113 (arrows #12).

In some examples, network controller 102 comprises a Uniform Data Management (UDM), and network database 103 comprises a Steering-of-Roaming Application Function (SoR-AF). Prioritized network list 104 may comprise a prioritized set of Public Land Mobile Network Identifiers (PLMN IDs), and access networks 111-113 may comprise the corresponding PLMNs.

In some examples, network controller 102 receives an authorization request from visited wireless network 110 for another roaming wireless device (not shown). In response, network controller 102 authorizes the other roaming wireless device and retrieves prioritized network list 104 for visited wireless network 110 from the controller memory and not from network database 103. Network controller 102 transfers prioritized network list 104 to the other roaming wireless device over visited wireless network 110. The other roaming wireless device wirelessly communicates over one of access networks 111-113 based on prioritized network list 104.

In some examples, network controller 102 receives an authorization from another visited wireless network (not shown) for roaming wireless device 101. In response, network controller 102 authorizes roaming wireless device to use the other network and retrieves a different prioritized network list for the other visited wireless network from network database 103. Network controller 102 transfers the other prioritized network list to roaming wireless device 101 over the other visited wireless network. Network controller 102 stores the other prioritized network list for the other visited wireless network in the controller memory. Subsequently, network controller 102 receives an authorization request from the other visited wireless network for roaming wireless device 101. In response, network controller 102 authorizes the roaming wireless device 101 and retrieves the different prioritized network list for the other visited wireless network from the controller memory and not from network database 103. Network controller 102 transfers the different prioritized network list to the roaming wireless device over the other visited wireless network. Roaming wireless device 101 wirelessly communicates over an access network in the other visited wireless network based on the different prioritized network list.

In some examples, network controller 102 receives an authorization request from another visited wireless network (not shown) for another roaming wireless device (not shown). In response, network controller 102 authorizes the other roaming wireless device to use the other visited wireless network and retrieves a different prioritized network list for the other visited wireless network from network database 103. Network controller 102 transfers the other prioritized network list to the other roaming wireless device over the other visited wireless network. Network controller 102 stores the other prioritized network list for the other visited wireless network in the controller memory. Subsequently, network controller 102 receives an authorization request from the other visited wireless network for the other roaming wireless device. In response, network controller 102 authorizes the other roaming wireless device and retrieves the different prioritized network list for the other visited wireless network from the controller memory and not from network database 103. Network controller 102 transfers the different prioritized network list to the other roaming wireless device over the other visited wireless network. The other roaming wireless device wirelessly communicates over an access network in the other visited wireless network based on the different prioritized network list.

Roaming wireless device 101 and visited wireless network 110 comprise radios that wirelessly communicate using wireless protocols like Wireless Fidelity (WIFI), Fifth Generation New Radio (5GNR), Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), and satellite data communications. Roaming wireless device 101, network controller 102, network database 103, visited wireless network 110, and access networks 111-113 comprise microprocessors, software, memories, transceivers, bus circuitry, and/or some other data processing components. The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of data communication system 100 as described herein.

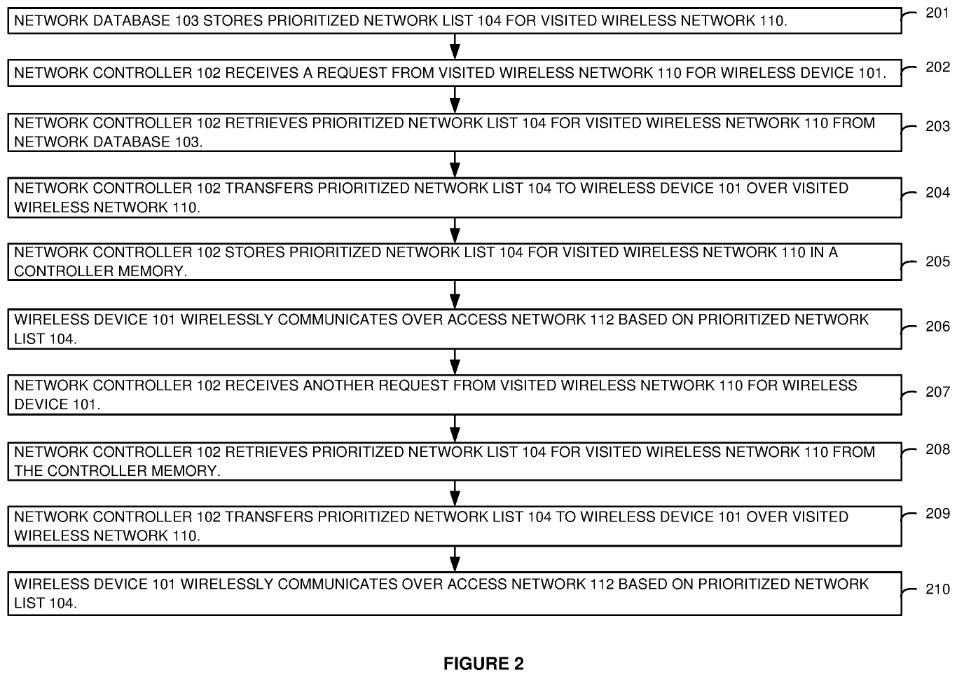

FIG. 2 illustrates an exemplary operation of data communication system 100 to control roaming wireless device 101 in visited wireless network 110. The operation may vary in other examples. Network database 103 stores prioritized network list 104 for visited wireless network 110 (201). Network controller 102 receives a request from visited wireless network 101 for roaming wireless device 101 (202). In response, network controller 102 retrieves prioritized network list 104 for visited wireless network 110 from network database 103 (203). Network controller 102 transfers prioritized network list 104 to roaming wireless device 101 over visited wireless network 110 (204). Network controller 102 stores prioritized network list 104 for visited wireless network 110 in a network controller memory (205). Roaming wireless device 101 wirelessly communicates over access network 112 based on prioritized network list 104 (206). Network controller 102 then receives another request from visited wireless network 110 for wireless device 101 (207). In response, network controller 102 retrieves prioritized network list 104 for visited wireless network 110 from the network controller memory—and not from network database 103 (208). Network controller 102 transfers prioritized network list 104 to wireless device 101 over visited wireless network 110 (209). Roaming wireless device 101 wirelessly communicates over access network 112 based on prioritized network list 104 (210).

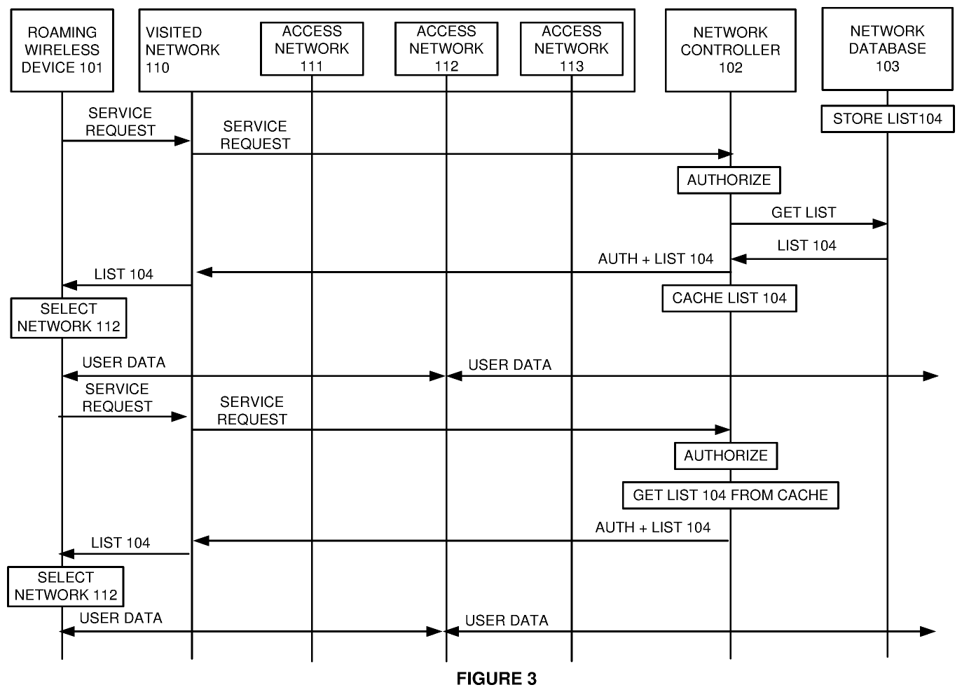

FIG. 3 illustrates an exemplary operation of data communication system 100 to control roaming wireless device 101 in visited wireless network 110. The operation may vary in other examples. Network database 103 stores prioritized network list 104 for visited wireless network 110. Roaming wireless device 101 transfers a service request to visited wireless network 110. Visited wireless network 110 transfers the service request to network controller 102. In response, network controller 102 authorizes roaming wireless device 101 and gets prioritized network list 104 for visited wireless network 110 from network database 103. Network controller 102 transfers the authorization and prioritized network list 104 to visited wireless network 110. Network controller 102 caches prioritized network list 104 for visited wireless network 110. Visited wireless network 110 transfers prioritized network list 104 to roaming wireless device 101 over visited wireless network 110. Roaming wireless device 101 selects access network 112 based on prioritized network list 104. Roaming wireless device 101 exchanges user data over access network 112.

Subsequently, roaming wireless device 101 transfers another service request to visited wireless network 110. Visited wireless network 110 transfers the other service request to network controller 102. In response, network controller 102 authorizes roaming wireless device 101 and gets prioritized network list 104 for visited wireless network 110 from its cache—and not from network database 103. Network controller 102 transfers the authorization and prioritized network list 104 to visited wireless network 110. Visited wireless network 110 transfers prioritized network list 104 to roaming wireless device 101 over visited wireless network 110. Roaming wireless device 101 selects access network 112 based on prioritized network list 104. Roaming wireless device 101 exchanges user data over access network 112.

Although not shown, network controller 102 may get prioritized network list 104 for visited wireless network 110 from the cache without using network database 103 for other roaming wireless devices that use visited wireless network 110 and network controller 102. Network controller 102 may cache another prioritized network list and then get the other prioritized network list for the other visited wireless network from the cache without using network database 103 for roaming wireless device 101 or other roaming devices that use the other visited wireless network.

Advantageously, network controller 102 serves network list 104 without excessive signaling which conserves network resources. Moreover, network controller 102 serves network list 104 from its own memory which reduces delay and speeds the delivery of wireless communication services in visited wireless network 110.

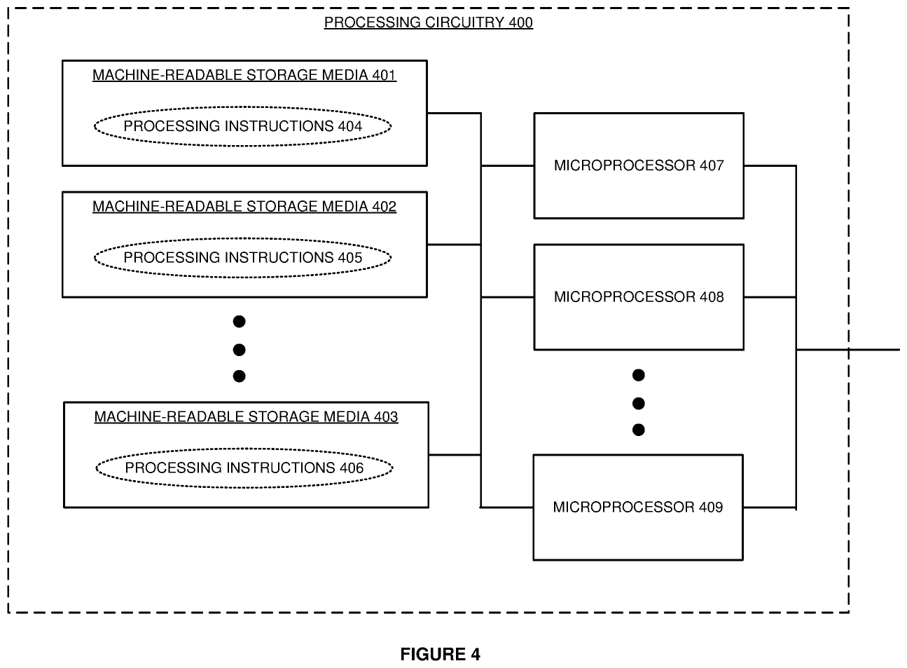

FIG. 4 illustrates exemplary processing circuitry 400 to control roaming wireless devices in visited wireless networks. Processing circuitry 400 comprises an example of roaming wireless device 101, network controller 102, network database 103, and visited wireless network 110, although device 101, controller 110, database 103, and network 110 may differ. Processing circuitry 400 comprises machine-readable storage media 401-403 and microprocessors 407-409 that are communicatively coupled. Machine-readable storage media 401-403 store processing instructions 404-406 in a non-transitory manner. Microprocessors 407-409 comprise DSPs, CPUs, GPUs, ASICs, and/or some other data processing hardware. Machine-readable storage media 401-403 comprises RAM, flash circuitry, disk drives, and/or some other type of data storage apparatus. Microprocessors 407-409 retrieve processing instructions 404-406 from non-transitory machine-readable storage media 401-403. Microprocessors 407-409 execute processing instructions 404-406 to control roaming wireless devices in visited wireless networks as described above for data communication system 100 and as described below for wireless communication network 500. The amount of storage media, microprocessors, processing instructions that are shown in FIG. 4 may vary in other examples.

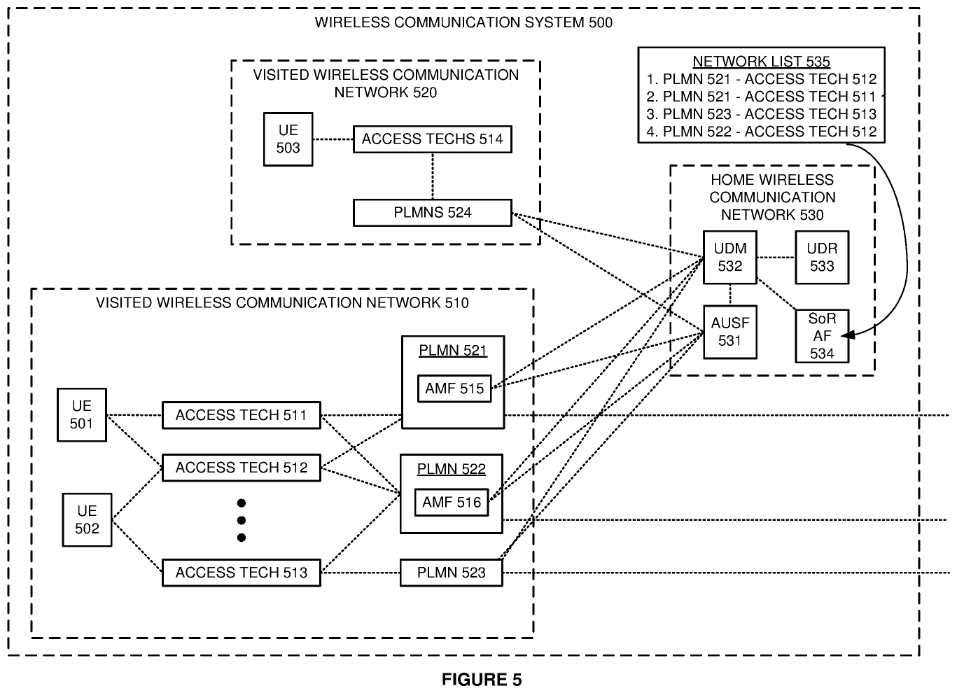

FIG. 5 illustrates exemplary wireless communication system 500 to control roaming wireless User Equipment (UEs) 501-503 in visited wireless communication networks 510 and 520. Wireless communication system 500 comprises an example of data communication system 100 and processing circuitry 400, although system 100 and circuitry 400 may differ. Wireless communication system 500 comprises visited wireless communication network 510, visited wireless communication network 520, and home wireless communication network 530. Visited wireless communication network 510 comprises User Equipment (UE) 501-502, access technologies 511-513, and Public Land Mobile Networks (PLMNs) 521-523. PLMN 521 comprises Access and Mobility Management Function (AMF) 515. PLMN 522 comprises AMF 516. Home wireless communication network 530 comprises Authorization Server Function (AUSF) 531, Unified Data Management (UDM) 532, Unified Data Repository (UDR) 533, and Steering-of-Roaming Application Function (SoR AF) 534. Visited wireless communication network 520 comprises UE 503, access technologies 514 and PLMNs 524.

SoR AF 534 stores network list 535 for PLMN 521 in visited wireless communication network 510 and home wireless communication network 530. Network list 535 indicates the following prioritized networks and access for UEs that are homed to home wireless communication network 530 but that are using PLMN 521 in visited wireless communication network 510. PLMN 521 and access technology 512 have the highest priority. PLMN 521 and access technology 511 have the second highest priority. PLMN 523 and access technology 513 have the third highest priority. PLMN 522 and access technology 512 have the fourth highest priority.

UE 501 is visiting PLMN 521 in wireless communication network 510 and is homed to wireless communication network 530. UE 501 initially attaches to access technology 511 (a 5GNR access node). UE 501 transfers a registration request to AMF 515 in PLMN 521 over access technology 511. AMF 515 transfers an authentication request to AUSF 531. AUSF 531 transfers the authentication request to UDM 532 which interacts with UDR 533 to obtain and generate authentication data for UE 501. UDM 532 transfers the authentication data to AUSF 531. AUSF 531 transfers the authentication data to AMF 515. AMF 515 and UE 501 perform an authentication session over access technology 511.

After UE authentication, AMF 515 transfers a User Equipment Context Management (UECM) registration to UDM 532. UDM 532 queries UDR 533 for context for UE 501. UDM 532 transfers a UECM registration OK message to AMF 515. AMF 515 transfers a Subscriber Data Management GET message to UDM 532. UDM 532 queries UDR 533 for subscriber data for UE 501. UDM 532 transfers a UECM registration OK message to AMF 515. UDM 532 detects that UE 501 is roaming on PLMN 521 based on these SDM interactions, and in response, transfers Steering-of-Roaming request to SoR AF 534 for PLMN 521. SoR AF 534 identifies SoR information for PLMN 521 in visited wireless communication network 510 which includes network list 535. SoR AF 534 transfers an SoR response to UDM 532 that incudes network list 535. UDM 532 caches network list 535 for PLMN 521 in visited wireless communication network 510.

UDM 532 transfers an SoR protection request to AUSF 531, and AUSF 531 returns an SoR protection response. After SoR protection is established, UDM 532 transfers an SoR response to AMF 515 that includes network list 535. AMF 515 transfers a registration accept message that includes network list 535 to UE 501 over access technology 511. UE 501 selects the highest priority network and access based on network list 535—access technology 512 and PLMN 521. UE 501 establishes service and exchanges data over access technology 512 and PLMN 521.

Subsequently, UE 501 attaches to access technology 512. UE 501 transfers a registration request to AMF 515 in PLMN 521 over access technology 512. AMF 515 transfers an authentication request to AUSF 531. AUSF 531 transfers the authentication request to UDM 532 which interacts with UDR 533 to obtain and generate authentication data for UE 501. UDM 532 transfers the authentication data to AUSF 531. AUSF 531 transfers the authentication data to AMF 515. AMF 515 and UE 501 perform an authentication session over access technology 512.

After UE authentication, AMF 515 transfers a UECM registration to UDM 532. UDM 532 queries UDR 533 for context for UE 501. UDM 532 transfers a UECM registration OK message to AMF 515. AMF 515 transfers an SDM GET message to UDM 532. UDM 532 queries UDR 533 for subscriber data for UE 501. UDM 532 transfers a UECM registration OK message to AMF 515. UDM 532 detects that UE 501 is roaming on PLMN 521 in visited network 510 based on the SDM interactions, and in response, retrieves network list 535 for PLMN 521 in visited network 510 from its cache. Note that UDM 532 does not need retrieve network list 535 from SoR AF 534.

UDM 532 transfers an SoR protection request to AUSF 531, and AUSF 531 returns an SoR protection response. After SoR protection is established, UDM 532 transfers an SoR response to AMF 515 that includes network list 535. AMF 515 transfers a registration accept message that includes network list 535 to UE 501 over access technology 512. UE 501 reselects the highest priority network and access based on network list 535—access tech 512 and PLMN 521. UE 501 establishes service and exchanges data over access technology 512 and PLMN 521.

Subsequently, network list 535 is modified in SoR AF 534. In response to the modification, SoR AF 534 transfers modified network list 535 to UDM 532. UDM 532 caches modified network list 535 for PLMN 521 in visited wireless network 510 in place of old network list 535. As described above for old network list 535, UDM 532 will retrieve modified network list 535 from its cache for PLMN 521 without accessing SoR AF 534 and will transfer modified network list 535 to UE 501 when it visits PLMN 521 in wireless communication network 510. UE 501 will use modified network list 535 to select the highest priority PLMN and access technology. In other examples, network list 535 may direct UE 501 to use a different PLMN than PLMN 521 as the highest priority. UE 501 would then register with the different PLMN in response to network list 535.

UE 502 is also in visited wireless communication network 510 and is homed to home wireless communication network 530. The above operation that was used above for UE 501 would also be used for UE 502 when visiting PLMN 521—and UDM 532 would use cached network list 535 from its cache if already available.

UE 503 is in visited wireless communication network 520 and is homed to home wireless communication network 530. The above operation that was used above for UE 501 would also be used for UE 503 except that UDM 532 typically uses a different network list for visited wireless communication network 520.

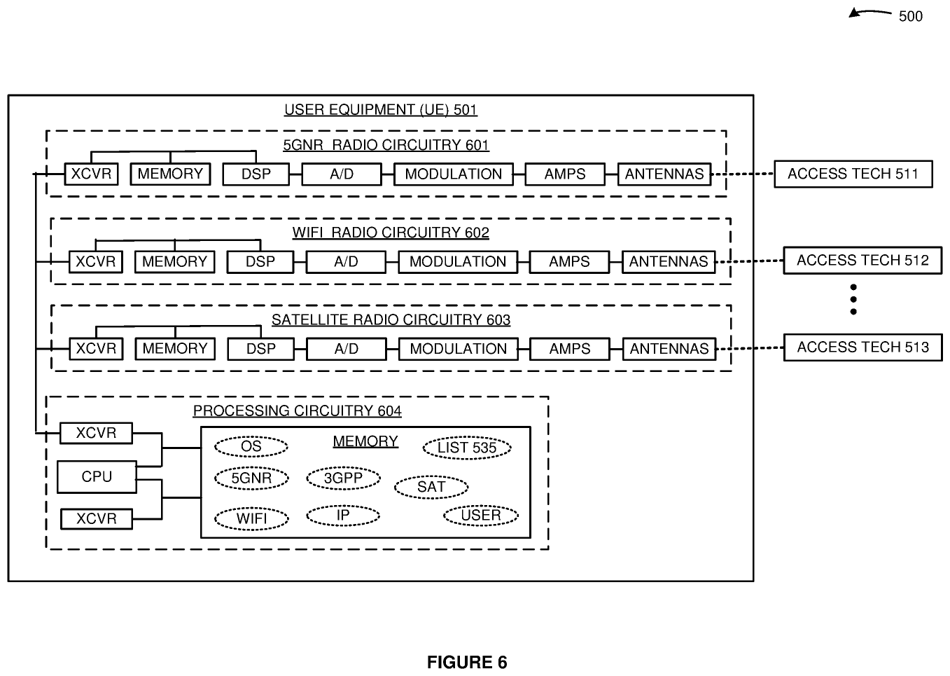

FIG. 6 illustrates exemplary UE 501 in wireless communication system 500 to control roaming wireless UEs 501-503 in visited wireless communication networks 510 and 540. UE 501 comprises an example of roaming wireless device 101, although device 101 may differ. UEs 502-503 could be similar. UE 501 comprises Fifth Generation New Radio (5GNR) radio circuitry 601, Wireless Fidelity (WIFI) radio circuitry 602, satellite radio circuitry 603, and processing circuitry 604. Radio circuitry 601-603 comprises antennas, amplifiers, filters, modulation, analog-to-digital interfaces, DSPs, memories, and transceivers (XCVRs) that are coupled over bus circuitry. Processing circuitry 604 comprises one or more CPUs, one or more memories, and one or more transceivers that are coupled over bus circuitry. The one or more memories in processing circuitry 604 store software like an Operating System (OS), 5GNR Application (5GNR), 3GPP Application (3GPP), WIFI Application (WIFI), Satellite Application (SAT), Internet Protocol application (IP), and eventually, network list 535. The antennas in radio circuitry 601-603 exchange wireless signals with access technologies 511-513. Transceivers in radio circuitry 601-603 are coupled to transceivers in processing circuitry 604. In processing circuitry 604, the one or more CPUs retrieve the software from the one or more memories and execute the software to direct the operation of UE 501 as described herein. For example, the CPU may execute the 3GPP app along with network list 535 to select the highest priority PLMNs and access technologies for visited wireless communication network 510.

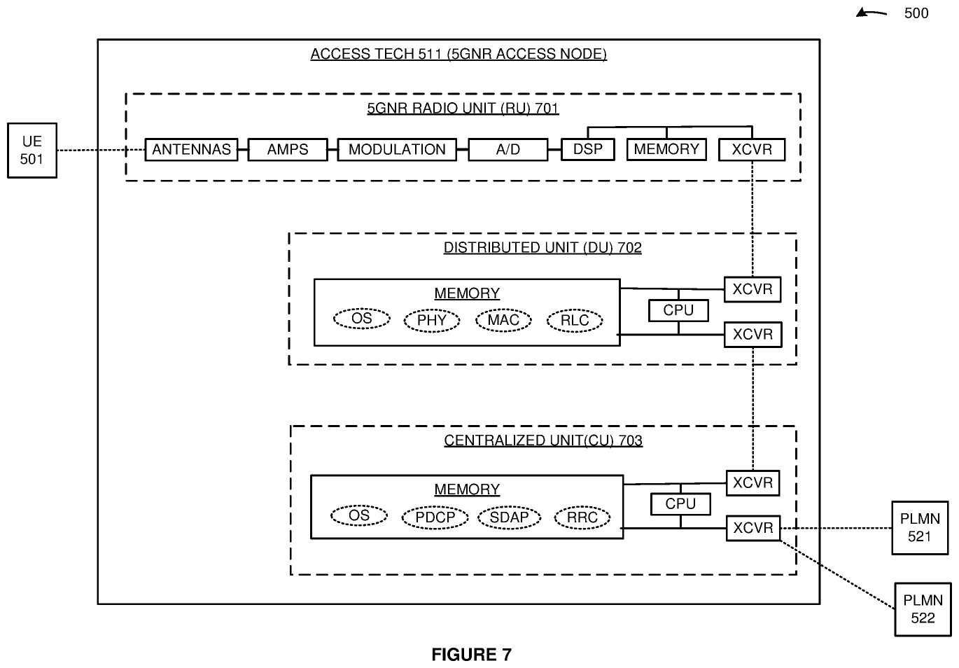

FIG. 7 illustrates exemplary access technology 511 (a Fifth Generation New Radio (5GNR) access node) in wireless communication system 500 to control roaming wireless UEs 501-503 in visited wireless communication networks 510 and 520. The 5GNR access node comprises an example of access networks 111-113 and processing circuitry 400, although networks 111-113 and circuitry 400 may differ. The 5GNR access node comprises 5GNR Radio Unit (RU) 701, Distributed Unit (DU) 702, and Centralized Unit (CU) 703. 5GNR RU 701 comprises antennas, amplifiers, filters, modulation, analog-to-digital interfaces, DSP, memory, radio applications, and transceivers that are coupled over bus circuitry. DU 702 comprises memory, CPU, user interfaces and components, and transceivers that are coupled over bus circuitry. The memory in DU 702 stores operating system and 5GNR network applications for Physical Layer (PHY), Media Access Control (MAC), and Radio Link Control (RLC). CU 703 comprises memory, CPU, and transceivers that are coupled over bus circuitry. The memory in CU 703 stores an operating system and 5GNR network applications for Packet Data Convergence Protocol (PDCP), Service Data Adaption Protocol (SDAP), and Radio Resource Control (RRC). The antennas in 5GNR RU 701 are wirelessly coupled to UE 501 over 5GNR links. Transceivers in 5GNR RU 701 are coupled to transceivers in DU 702. Transceivers in DU 702 are coupled to transceivers in CU 703. Transceivers in CU 703 are coupled to transceivers in PLMNs 521-522. The DSP and CPU in RU 701, DU 702, and CU 703 execute the radio applications, operating systems, and network applications to exchange data and signaling between UE 501 and PLMNs 521-522 as described herein.

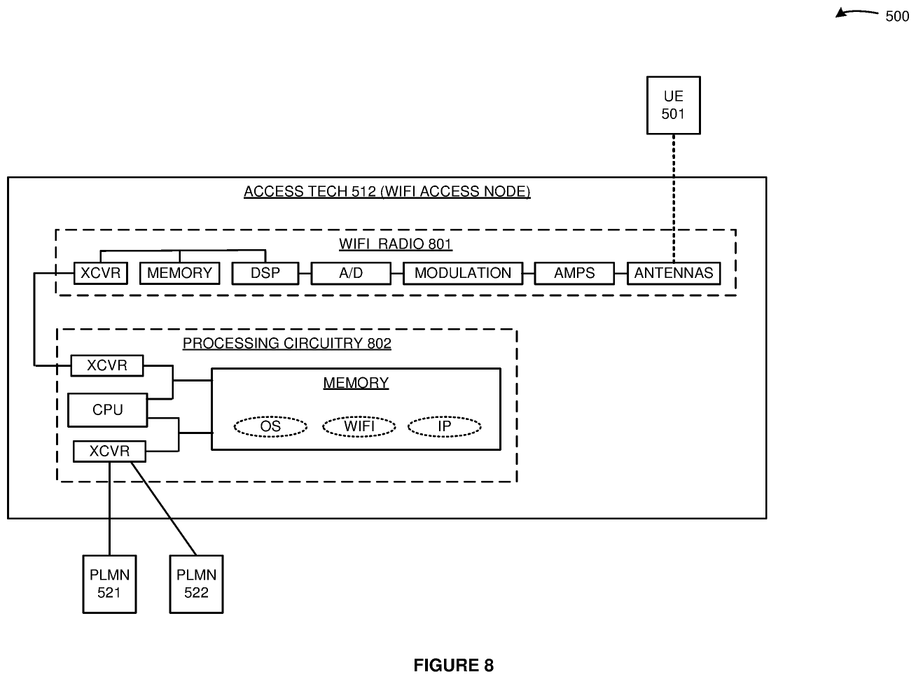

FIG. 8 illustrates exemplary access technology 512 (a Wireless Fidelity (WIFI) access node) in wireless communication system 500 to control roaming wireless UEs 501-503 in visited wireless communication networks 510 and 520. The WIFI access node comprises an example of access networks 111-113 and processing circuitry 400, although networks 111-113 and circuitry 400 may differ. The WIFI access node comprises WIFI radio 801 and processing circuitry 802. Radio 801 comprises antennas, amplifiers, filters, modulation, analog-to-digital interfaces, DSPs, memories, and transceivers that are coupled over bus circuitry. Processing circuitry 802 comprises one or more CPUs, one or more memories, and one or more transceivers that are coupled over bus circuitry. The one or more memories in processing circuitry 802 store software like an Operating System (OS), WIFI application (WIFI), and IP application (IP). The antennas in WIFI radio 801 exchange WIFI signals with UE 501. Transceivers in radio 801 are coupled to transceivers in processing circuitry 802. Transceivers in processing circuitry 802 are coupled to transceivers in PLMNs 521-522. In processing circuitry 802, the one or more CPUs retrieve the software from the one or more memories and execute the software to exchange data and signaling between UE 501 and PLMNs 521-522 as described herein.

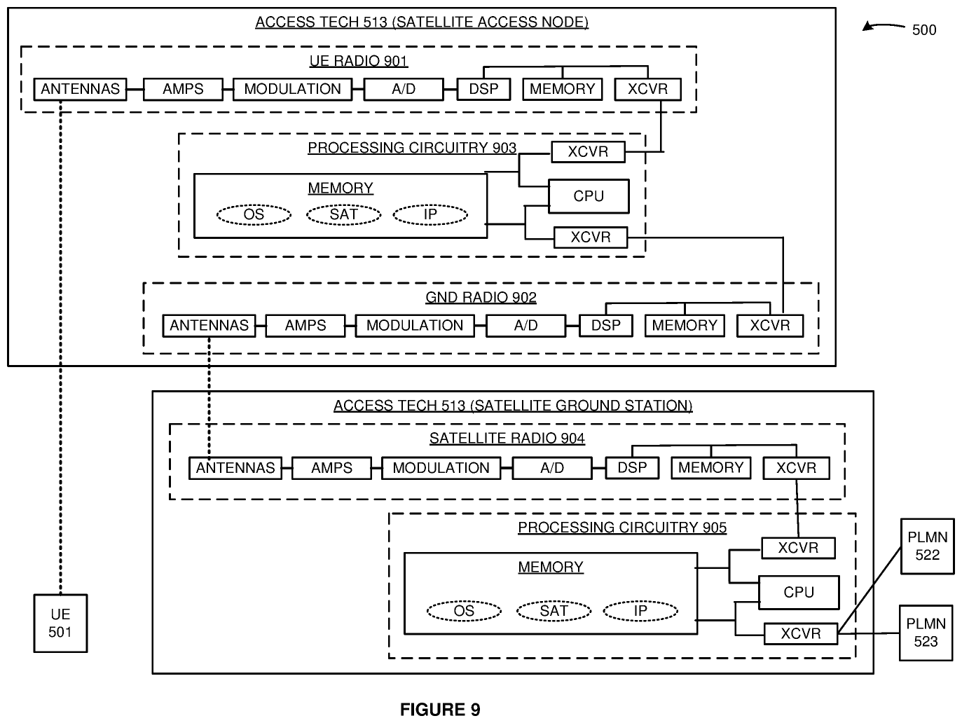

FIG. 9 illustrates exemplary access technology 513 (a satellite access node and satellite ground station) in wireless communication system 500 to control roaming wireless UEs 501-503 in visited wireless communication networks 510 and 520. The satellite access node and satellite ground station comprise examples of access networks 111-113 and processing circuitry 400, although networks 111-113 and circuitry 400 may differ. The satellite access node comprises UE radio 901, GND radio 902 and processing circuitry 903. The satellite ground station comprises satellite radio 904 and processing circuitry 905. Radios 901-902 and 904 comprise antennas, amplifiers, filters, modulation, analog-to-digital interfaces, DSPs, memories, and transceivers that are coupled over bus circuitry. Processing circuitry 903 and 905 comprise one or more CPUs, one or more memories, and one or more transceivers that are coupled over bus circuitry. The one or more memories in processing circuitry 903 and 905 store software like an Operating System (OS), Satellite Application (SAT), and IP Application (IP). The antennas in UE radio 901 exchange satellite signals with UE 501. Transceivers in UE radio 901 are coupled to transceivers in processing circuitry 903. Transceivers in processing circuitry 903 are coupled to transceivers in GND radio 902. The antennas in GND radio 902 exchange satellite signals with antennas in satellite radio 904, and the antennas in satellite radio 904 exchange the satellite signals with GND radio 902. Transceivers in satellite radio 904 are coupled to transceivers in processing circuitry 905. Transceivers in processing circuitry 905 are coupled to transceivers in PLMNs 522-523. In processing circuitry 903 and 905, the one or more CPUs retrieve the software from the one or more memories and execute the software to exchange data and signaling between UE 501 and PLMNs 522-523 as described herein.

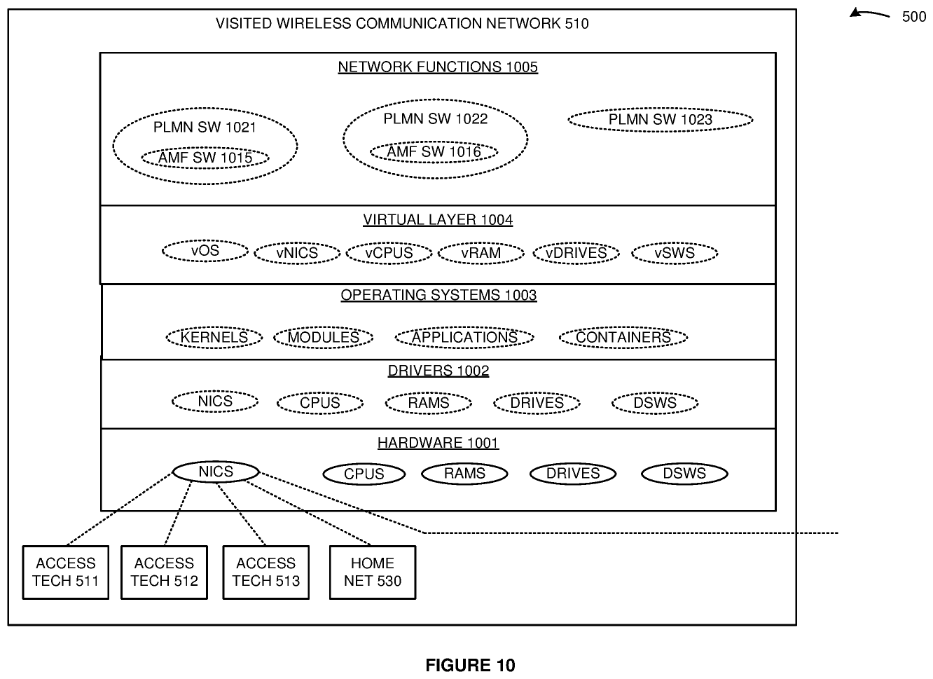

FIG. 10 illustrates exemplary visited wireless communication network 510 in wireless communication system 500 to control roaming wireless UEs 501-503 in visited wireless communication networks 510 and 520. Visited wireless communication network 510 comprises an example of visited wireless communication network 110 and processing circuitry 400, although network 110 and circuitry 400 may differ. Visited wireless communication network 520 could be similar to network 510. Visited wireless communication network 510 includes Network Function Virtualization Infrastructure (NFVI) equipment that comprises hardware 1001, hardware drivers 1002, operating systems 1003, virtual layer 1004, and network functions 1005. Hardware 1001 comprises Network Interface Cards (NICS), CPUS, RAM, Flash/Disk Drives (DRIVES), and Data Switches (DSWS). Hardware drivers 1002 comprise software that is resident in the NICS, CPUS, RAM, DRIVES, and DSWS. Operating systems 1003 comprise kernels, modules, applications, and containers. Virtual layer 1004 comprises virtual Operating Systems (vOS), vNICS, vCPUS, vRAM, vDRIVES, and vSWS. Network Functions 1005 comprises PLMN SW 1021, PLMN SW 1022, and PLMN SW 1023. PLMN SW 1021 comprises AMF SW 1015 and other network functions. PLMN SW 1022 comprises AMF SW 1016 and other network functions. The NICS in hardware 1001 are coupled to access technologies 511-513, home network 530, and external systems. Hardware 1001 executes hardware drivers 1002, operating systems 1003, virtual layer 1004, and network functions 1005 to form and operate PLMNs 1021-1023. Visited wireless communication network 510 comprises one or more microprocessors and one or more non-transitory machine-readable storage media that store processing instructions that direct visited wireless communication network 510 to exchange data and signaling between access technologies 511-513, home network 530, and external systems as described herein. Visited wireless communication network 510 may be located at a single site or be distributed across multiple geographic locations.

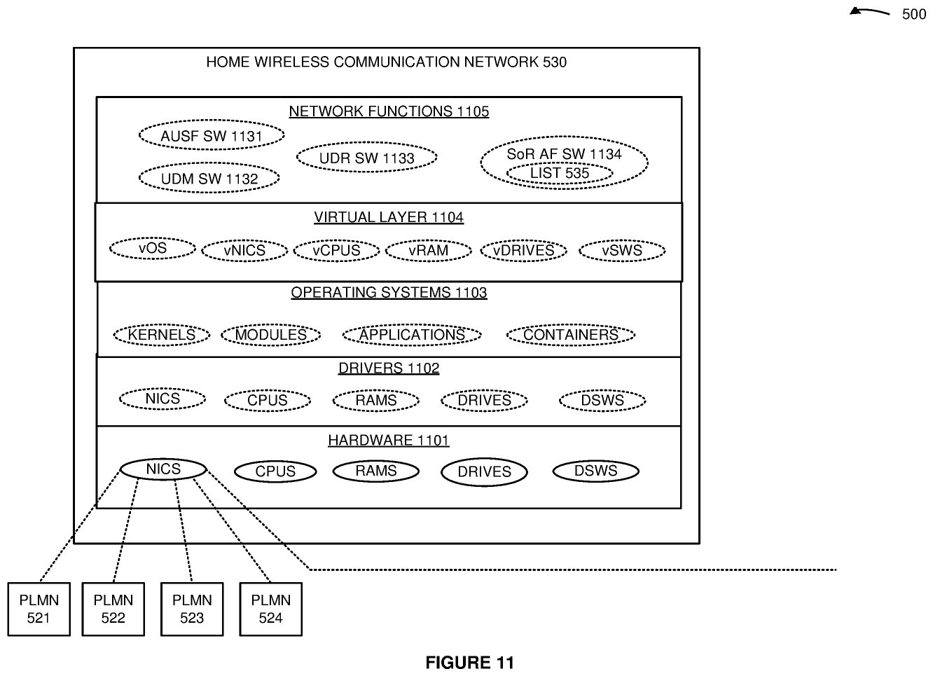

FIG. 11 illustrates exemplary home wireless communication network 530 in wireless communication system 500 to control roaming wireless UEs 501-503 in visited wireless communication networks 510 and 520. Home wireless communication network 530 comprises an example of network controller 102, network database 103, and processing circuitry 400, although controller 102, database 103, and circuitry 400 may differ. Home wireless communication network 530 includes NFVI equipment that comprises hardware 1101, hardware drivers 1102, operating systems 1103, virtual layer 1104, and network functions 1105. Hardware 1101 comprises Network Interface Cards (NICS), CPUS, RAM, Flash/Disk Drives (DRIVES), and Data Switches (DSWS). Hardware drivers 1102 comprise software that is resident in the NICS, CPUS, RAM, DRIVES, and DSWS. Operating systems 1103 comprise kernels, modules, applications, and containers. Virtual layer 1104 comprises virtual Operating Systems (vOS), vNICS, vCPUS, vRAM, vDRIVES, and vSWS. Network Functions 1105 comprise AUSF SW 1131, UDM SW 1132, UDR SW 1133, and SoR AF SW 1134. The NICS in hardware 1001 are coupled to PLMNs 521-524 and external systems. Hardware 1101 executes hardware drivers 1102, operating systems 1103, virtual layer 1104, and network functions 1105 to form and operate AUSF 531, UDM 532, UDR 433, and SoR AF 534 as described herein. Home wireless communication network 530 includes NFVI equipment that comprises one or more microprocessors and one or more non-transitory machine-readable storage media that store processing instructions that direct home wireless communication network 530 to exchange data and signaling between PLMNs 521-524, home network 530, and external systems as described herein. Home wireless communication network 530 may be located at a single site or be distributed across multiple geographic locations.

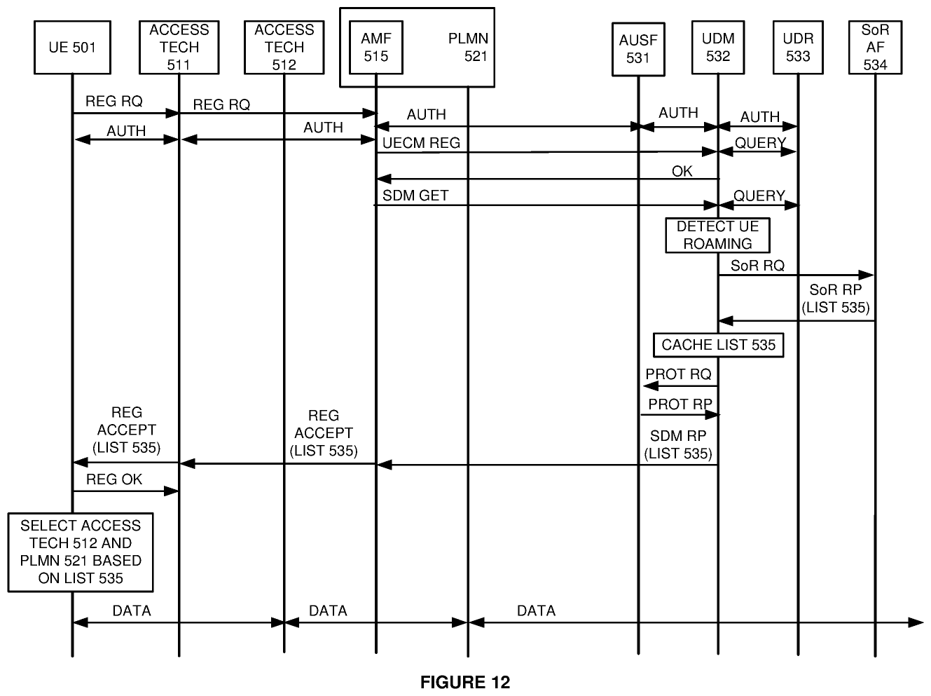

FIG. 12 illustrates an exemplary operation of wireless communication system 500 to control roaming wireless UE 501 in visited wireless communication network 510. The following operation may vary in other examples. UE 501 attaches to access technology 511 (a 5GNR access node). UE 501 transfers a registration request (REG RQ) to AMF 515 over access technology 511. AMF 515 transfers an authentication request to AUSF 531. AUSF 531 transfers the authentication request to UDM 532 which interacts with UDR 533 to obtain and generate authentication data for UE 501. UDM 532 transfers the authentication data to AUSF 531. AUSF 531 transfers the authentication data to AMF 515. AMF 515 and UE 501 perform an authentication session over access technology 511.

After UE authentication, AMF 515 transfers a User Equipment Context Management (UECM) registration to UDM 532. UDM 532 queries UDR 533 for context for UE 501. UDM 532 transfers a UECM registration OK message to AMF 515. AMF 515 transfers a Subscriber Data Management (SDM) GET message to UDM 532. UDM 532 queries UDR 533 for subscriber data for UE 501. UDM 532 transfers a UECM registration OK message to AMF 515. UDM 532 detects that UE 501 is roaming on PLMN 521 in visited network 510 based on the SDM interactions, and in response, transfers Steering-of-Roaming Request (SoR RQ) to SoR AF 534 for PLMN 521. SoR AF 534 identifies SoR information for visited wireless communication network 510 which includes network list 535. SoR AF 534 transfers an SoR Response (RP) to UDM 532 that incudes network list 535. UDM 532 caches network list 535 for PLMN 521 in visited wireless communication network 510.

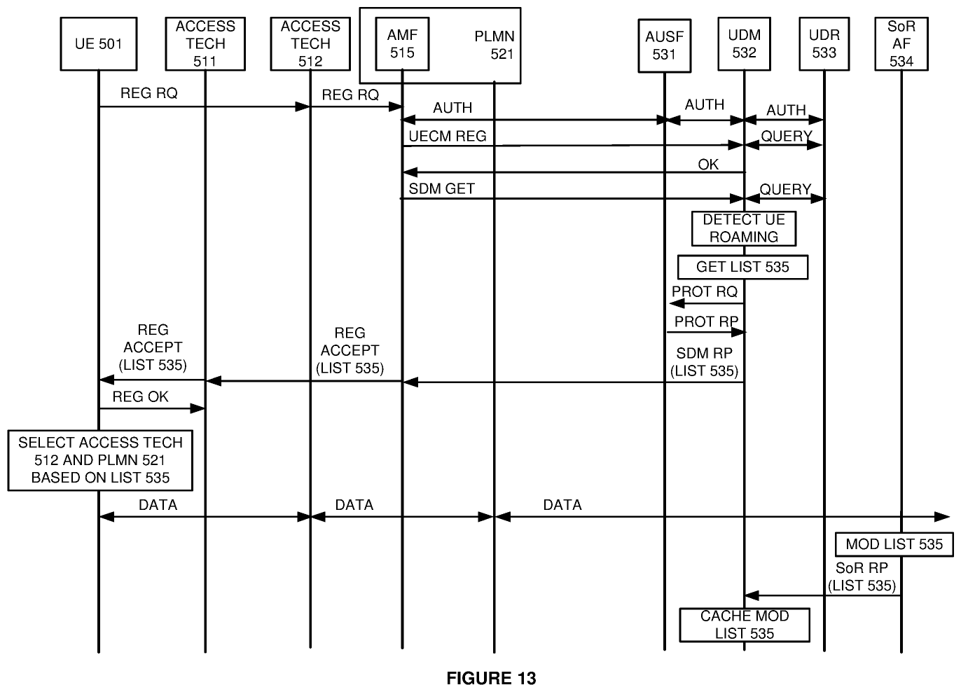

UDM 532 transfers an SoR protection (PROT) request to AUSF 531, and AUSF 531 returns an SoR protection response. After SoR protection is established, UDM transfer an SoR response to AMF 515 that includes network list 535. AMF 515 transfers a registration accept message that includes network list 535 to UE 501 over access technology 511. Network list 535 has access technology 512 (a WIFI access node) and PLMN 521 as the highest priority for UE 501 when visiting PLMN 521 in network 510. UE 501 selects access technology 512 and PLMN 521 based on network list 535. UE 501 establishes service and exchanges data over access technology 512 and PLMN 521. The operation continues on FIG. 13.

FIG. 13 illustrates an exemplary operation of wireless communication system 500 to control roaming wireless UE 501 in visited wireless communication network 510. The following operation is continued from FIG. 12 may vary in other examples. UE 501 attaches to access technology 512. UE 501 transfers a registration request to AMF 515 over access technology 512. AMF 515 transfers an authentication request to AUSF 531. AUSF 531 transfers the authentication request to UDM 532 which interacts with UDR 533 to obtain and generate authentication data for UE 501. UDM 532 transfers the authentication data to AUSF 531. AUSF 531 transfers the authentication data to AMF 515. AMF 515 and UE 501 perform an authentication session over access technology 512.

After UE authentication, AMF 515 transfers a UECM registration to UDM 532. UDM 532 queries UDR 533 for context for UE 501. UDM 532 transfers a UECM registration OK message to AMF 515. AMF 515 transfers an SDM GET message to UDM 532. UDM 532 queries UDR 533 for subscriber data for UE 501. UDM 532 transfers a UECM registration OK message to AMF 516. UDM 532 detects that UE 501 is roaming on PLMN 521 in network 510 based on the SDM interactions, and in response, retrieves network list 535 from its cache but does not retrieve network list 535 from SoR AF 534. SoR AF 534 transfers an SoR response to UDM 532 that incudes network list 535.

UDM 532 transfers an SoR protection request to AUSF 531, and AUSF 531 returns an SoR protection response. After SoR protection is established, UDM 532 transfers an SoR response to AMF 515 that includes network list 535. AMF 515 transfers a registration accept message that includes network list 535 to UE 501 over access technology 512. UE 501 reselects access tech 512 and PLMN 521 based on network list 535. UE 501 establishes service and exchanges data over access technology 512 and PLMN 521.

Subsequently, network list 535 is modified in SoR AF 534. In response to the modification, SoR AF 534 transfers modified network list 535 to UDM 532. UDM 532 caches modified network list 535 for PLMN 521 in visited wireless network 510 in place of old network list 535. As described above for old network list 535, UDM 532 will retrieve modified network list 535 from its cache without accessing SoR AF 534 and will transfer modified network list 535 to UE 501 when it visits PLMN 521 in wireless network 510. UE 501 will use modified network list 535 to select the highest priority access technology and PLMN.

Although not shown on FIGS. 12-13, network list 535 may direct UE 501 to use a different PLMN than PLMN 521 as the highest priority. UE 501 would then register with the different PLMN in response to network list 535. Other UEs on PLMN 521 in visited wireless communication network 510 that are homed to home wireless communication network 530 may use cached network list 535 in a similar manner to UE 501 without requiring UDM 532 to retrieve network list 535 from SoR AF 534. In other visited wireless communication networks, UE 501 may use other cached network lists in a similar manner to network list 535 without requiring UDM 532 to retrieve the other network lists from SoR AF 534.

Advantageously, UDR 532 serves network list 535 without excessive signaling with SoR AF 534 to conserve network resources. Moreover, UDR 532 serves network list 535 from its own memory which reduces delay and speeds the delivery of wireless communication services in visited wireless communication networks 510 and 520.

The wireless communication system circuitry described above comprises computer hardware and software that form special-purpose data communication circuitry system to control roaming wireless UEs in visited wireless communication networks. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose data communication circuitry system to control roaming wireless UEs in visited wireless communication networks.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method to control a wireless device in a visited wireless network, the method comprising:
a network database storing a prioritized network list for the visited wireless network;
a network controller receiving a request from the visited wireless network for the wireless device, and in response, retrieving the prioritized network list for the visited wireless network from the network database, transferring the prioritized network list to the wireless device over the visited wireless network, and storing the prioritized network list for the visited wireless network in a controller memory; and
the network controller receiving another request from the visited wireless network for the wireless device, and in response, retrieving the prioritized network list for the visited wireless network from the controller memory and transferring the prioritized network list to the wireless device over the visited wireless network, wherein the wireless device wirelessly communicates based on the prioritized network list.

2. The method of claim 1 further comprising:
the network controller receiving a different request from the visited wireless network for another wireless device, and in response, retrieving the prioritized network list for the visited wireless network from the controller memory and transferring the prioritized network list to the other wireless device over the visited wireless network, wherein the other wireless device wirelessly communicates based on the prioritized network list.

3. The method of claim 1 further comprising:
the network controller receiving a different request from another visited wireless network for the wireless device, and in response, retrieving another prioritized network list for the other visited wireless network from the network database, transferring the other prioritized network list to the wireless device over the other visited wireless network, and storing the other prioritized network list for the other visited wireless network in the controller memory; and
the network controller receiving a subsequent request from the other visited wireless network for the wireless device, and in response, retrieving the other prioritized network list for the other visited wireless network from the controller memory and transferring the other prioritized network list to the wireless device over the other visited wireless network, wherein the wireless device wirelessly communicates based on the other prioritized network list.

4. The method of claim 1 further comprising:
the network controller receiving a different request from another visited wireless network for another wireless device, and in response, retrieving another prioritized network list for the other visited wireless network, transferring the other prioritized network list to the other wireless device over the other visited wireless network, and storing the other prioritized network list for the other visited wireless network in the controller memory; and
the network controller receiving a subsequent request from the other visited wireless network for the other wireless device, and in response, retrieving the other prioritized network list for the other visited wireless network from the controller memory and transferring the other prioritized network list to the other wireless device over the other visited wireless network, wherein the other wireless device wirelessly communicates based on the other prioritized network list.

5. The method of claim 1 wherein the network database comprises a Steering-of-Roaming Application Function (SoR-AF).

6. The method of claim 1 wherein the network controller comprises a Uniform Data Management (UDM).

7. The method of claim 1 wherein:
the network database comprises a Steering-of-Roaming Application Function (SoR-AF); and
the network controller comprises a Uniform Data Management (UDM).

8. The method of claim 1 wherein the prioritized network list comprises a prioritized set of Public Land Mobile Network Identifiers (PLMN IDs).

9. The method of claim 1 further comprising the network database modifying the prioritized network list for the visited wireless network, and in response, automatically pushing the modified prioritized network list to the network controller.

10. A method to control roaming devices in visited wireless networks, the method comprising:
a Steering-of-Roaming Application Function (SoR-AF) storing sets of Public Land Mobile Network Identifiers (PLMN IDs) for the visited wireless networks;
a Uniform Data Management (UDM) receiving roaming requests from the visited wireless networks for the roaming devices, and in response, retrieving the sets of the PLMN IDs for the visited wireless networks from the SoR-AF, transferring the sets of the PLMN IDs to the roaming devices over the visited wireless networks, and storing the sets of the PLMN IDs for the visited wireless networks in a UDM memory; and
the UDM receiving other additional roaming requests from the visited wireless networks for the roaming devices, and in response, retrieving the sets of the PLMN IDs for the visited wireless networks from the UDM memory and transferring the sets of the PLMN IDs to the roaming devices over the visited wireless networks, wherein the roaming devices wirelessly communicate based on the sets of the PLMN IDs.

11. The method of claim 10 further comprising the SoR-AF modifying one of the sets of the PLMN IDs for one of the visited wireless networks, and in response, automatically pushing the modified set of the PLMN IDs to the UDM.

12. A wireless communication system to control a wireless device in a visited wireless network, the wireless communication system comprising:
a network database to store a prioritized network list for the visited wireless network;
a network controller to receive a request from the visited wireless network for the wireless device, and in response, retrieve the prioritized network list for the visited wireless network from the network database, transfer the prioritized network list to the wireless device over the visited wireless network, and store the prioritized network list for the visited wireless network in a controller memory; and
the network controller to receive another request from the visited wireless network for the wireless device, and in response, retrieve the prioritized network list for the visited wireless network from the controller memory and transfer the prioritized network list to the wireless device over the visited wireless network, wherein the wireless device is to wirelessly communicate based on the prioritized network list.

13. The wireless communication system of claim 12 further comprising:
the network controller to receive a different request from the visited wireless network for another wireless device, and in response, retrieve the prioritized network list for the visited wireless network from the controller memory and transfer the prioritized network list to the other wireless device over the visited wireless network, wherein the other wireless device is to wirelessly communicate based on the prioritized network list.

14. The wireless communication system of claim 12 further comprising:
the network controller to receive a different request from another visited wireless network for the wireless device, and in response, retrieve another prioritized network list for the other visited wireless network, transfer the other prioritized network list to the wireless device over the other visited wireless network, and store the other prioritized network list for the other visited wireless network in the controller memory; and
the network controller to receive a subsequent request from the other visited wireless network for the wireless device, and in response, retrieve the other prioritized network list for the other visited wireless network from the controller memory and transfer the other prioritized network list to the wireless device over the other visited wireless network, wherein the wireless device is to wirelessly communicate based on the other prioritized network list.

15. The wireless communication system of claim 12 further comprising:
the network controller to receive a different request from another visited wireless network for another wireless device, and in response, retrieve another prioritized network list for the other visited wireless network, transfer the other prioritized network list to the other wireless device over the other visited wireless network, and store the other prioritized network list for the other visited wireless network in the controller memory; and
the network controller to receive a subsequent request from the other visited wireless network for the other wireless device, and in response, retrieve the other prioritized network list for the other visited wireless network from the controller memory and transfer the other prioritized network list to the other wireless device over the other visited wireless network, wherein the other wireless device is to wirelessly communicate based on the other prioritized network list.

16. The wireless communication system of claim 12 wherein the network database comprises a Steering-of-Roaming Application Function (SoR-AF).

17. The wireless communication system of claim 12 wherein the network controller comprises a Uniform Data Management (UDM).

18. The wireless communication system of claim 12 wherein:
the network database comprises a Steering-of-Roaming Application Function (SoR-AF); and
the network controller comprises a Uniform Data Management (UDM).

19. The wireless communication system of claim 12 wherein the prioritized network list comprises a prioritized set of Public Land Mobile Network Identifiers (PLMN IDs).

20. The wireless communication system of claim 12 further comprising the network database to modify the prioritized network list for the visited wireless network, and in response, automatically push the modified prioritized network list to the network controller.
